(19) United States
(12) Patent Application Publication
(10) Pub. No.: US 2009/0288052 A1
(43) Pub. Date: Nov. 19, 2009

(54) METHOD AND APPARATUS FOR ANALYZING CIRCUIT

(75) Inventor: Satoshi SUNOHARA, Kanagawa (JP)

Correspondence Address: YOUNG & THOMPSON, 209 Madison Street, Suite 500, ALEXANDRIA, VA, 22314, US

(73) Assignee: NEC ELETRONICS CORPORATION, Kanagawa (JP)

(21) Appl. No.: 12/464,120

(22) Filed: May 12, 2009

(30) Foreign Application Priority Data
May 15, 2008 (JP) 2008-128152

(51) Int. Cl. G06F 17/50

(52) U.S. Cl. 716/6

(57) ABSTRACT

In a circuit analyzing method, coordinate points of nodes in an analysis target circuit are detected from layout data of the analysis target circuit to store in a storage unit, and a minimum area from among areas is specified by referring to a storage unit to read out the coordinate points of the nodes and by defining the areas containing all the nodes based on the read coordinate points of the nodes. A distance parameter prescribing a size of the minimum area is calculated, a variation coefficient is specified by using the distance parameter. Thus, a delay time in the analysis target circuit is calculated by using the variation coefficient.

### INCORPORATION BY REFERENCE

This patent application claims a priority on convention based on Japanese Patent Application 2008-128152. The disclosure thereof is incorporated herein by reference.

### BACKGROUND OF THE INVENTION

1. Field of the Invention

The present invention relates to a circuit analyzing method, and a circuit analyzing apparatus, and especially relates to a circuit analyzing method and a circuit analyzing apparatus which carry out a timing analysis of a design target circuit.

2. Description of Related Art

In a timing analysis of an integrated circuit, it is required to consider a variation of delay time between paths in calculating the delay time. In this case, a maximum delay time and a minimum delay time caused due to the variation are calculated by multiplying the delay time of each path by a uniform variation coefficient. The variation coefficient is calculated in consideration of: a distance dependent variation (a systematic component) that depends on a position in a circuit and on a distance between two elements; and a variation (a random component) that appears in each stage or each element on the path and is not related to a variation in another element.

For example, Japanese Patent Application Publication (JP-P2005-100310A) discloses a technique of separating a relative variation of delay time in two paths into the systematic component and the random component and calculating the delay time by using the systematic component and the random component. In this technique, the systematic component of the relative variation of the delay time is obtained by using a distance between the stages in paring paths and the delay time of the stages. In addition, the random component of the relative variation of the delay time is obtained based on the number of steps of the stage in each path.

In the technique described in Japanese Patent Application Publication (JP-P2005-100310A), the systematic component of the relative variation of the delay time is defined as a function depending on the distance between the elements (stages) in the two paths. Here, delay variation (a variation coefficient) of the systematic component in the element (the stage) at an n^{th} step is calculated by summing up the variation coefficients calculated based on distances between the elements at the nth step and each of the elements on the paths

As described above, the systematic component requires calculation of the variation coefficients with all the elements on the paths. For this reason, a calculation amount of the systematic component of the relative variation is increased with an increase of the number of elements in an analysis target circuit.

A technique is employed to suppress the above-mentioned increase of the calculation amount, and in the technique, an approximate value of the systematic component of a delay time in the analysis target circuit is calculated by using a predetermined value (a distance parameter) instead of a distance between the elements (the stages) in the paths. For example, the systematic component of the variation coefficient is calculated based on a diagonal line of a rectangle including all nodes (elements) in the analysis target circuit. Specifically, all combinational circuits forming the paths in the analysis target circuit are regarded as the node, and X-Y coordinates of the node is extracted. Referring to the extracted coordinates of the node, a node with a minimum X coordinate, a node with a minimum Y coordinate, a node with a maximum X coordinate, and a node with a maximum Y coordinate are retrieved. A rectangle passing the retrieved nodes and having sides parallel to an X axis and a Y axis is defined. Then, a diagonal line of the rectangle is substituted to the distance between the elements (the distance parameter) of a function for obtaining the systematic component, and the systematic component of the variation coefficient is calculated. The systematic component calculated by using the diagonal line length of the rectangle including all nodes takes a value approximate to the maximum value of the variation of delay time. The timing analysis under a severest constraint condition can be carried out on the analysis target circuit at high speed by using such approximated systematic component.

Meanwhile, a shape of an analysis target, that is, a shape of a region in which the nodes (the elements) in the circuit are distributed is different for each circuit. In addition, since a method according to a conventional technique defines a rectangle by directly using coordinates of layout data of the analysis target circuit, a diagonal line of the rectangle is sometimes defined to be longer than necessary. In this case, distance dependence of LOVC (Location level based On Chip Variation) becomes a pessimistic factor, and as a result, the timing analysis under a severest constraint condition is carried out. Specifically, when the delay analysis is carried out by the conventional method, a highly-accurate circuit analysis cannot be realized because the constraint condition for the variation of a delay time becomes a pessimistic factor. In addition, circuit designing requires a design margin based on the variation. For this reason, when the delay time widely varies, the wide design margin is required and much time is required for a design convergence.

### SUMMARY

In an aspect of the present invention, a circuit analyzing method is achieved by detecting coordinate points of nodes in an analysis target circuit from layout data of the analysis target circuit to store in a storage unit; by specifying a minimum area from among areas by referring to a storage unit to read out the coordinate points of the nodes and by defining the areas containing all the nodes based on the read coordinate points of the nodes; by calculating a distance parameter prescribing a size of the minimum area; by specifying a variation coefficient by using the distance parameter; and by calculating a delay time in the analysis target circuit by using the variation coefficient.

In another aspect of the present invention, a circuit analyzing method is achieved by detecting coordinate points of nodes in an analysis target circuit from layout data of the analysis target circuit; by specifying two nodes of the nodes based on the coordinate points of the nodes such that a distance between the two nodes is maximum; by specifying a variation coefficient by using the distance between the two nodes; and by calculating a delay time in the analysis target circuit by using the variation coefficient.

In still another aspect of the present invention, a circuit analyzing apparatus includes: a storage unit which stores layout data of an analysis target circuit; an analysis path position specifying section configured to detect coordinate points of nodes in the analysis target circuit from the layout data of the analysis target circuit; a distance parameter calculating section configured to define areas containing all the nodes based on the coordinate points of the nodes, specify a minimum area from among the areas and calculate a distance parameter prescribing a size of the minimum area; a variation coefficient specifying section configured to specify a variation coefficient by using the distance parameter; and a delay time calculating section configured to calculate a delay time in the analysis target circuit by using the variation coefficient.

In still another aspect of the present invention, a circuit analyzing apparatus includes: a storage unit which stores layout data of an analysis target circuit; an analysis path position specifying section configured to configured to detect coordinate points of nodes in the analysis target circuit from the layout data of the analysis target circuit; an analysis path position specifying section configured to detect coordinate points of nodes in the analysis target circuit from the layout data of the analysis target circuit; a distance parameter calculating section configured to specify two nodes of the nodes based on the coordinate points of the nodes such that a distance between the two nodes is maximum; a variation coefficient specifying section configured to specify a variation coefficient by using the distance between the two nodes; and a delay time calculating section configured to calculate a delay time in the analysis target circuit by using the variation coefficient.

In yet still another aspect of the present invention, a computer-readable recording medium in which a computer-readable program code is stored to realize a circuit analyzing method, which is achieved by detecting coordinate points of nodes in an analysis target circuit from layout data of the analysis target circuit; by specifying a minimum area from among areas by defining the areas containing all the nodes based on the coordinate points of the nodes; by calculating a distance parameter prescribing a size of the minimum area; by specifying a variation coefficient by using the distance parameter; and by calculating a delay time in the analysis target circuit by using the variation coefficient.

Also, in another aspect of the present invention, a computer-readable recording medium in which a computer-readable program code is stored to realize a circuit analyzing method, which is achieved by detecting coordinate points of nodes in an analysis target circuit from layout data of the analysis target circuit; by specifying two nodes of the nodes based on the coordinate points of the nodes such that a distance between the two nodes is maximum; by specifying a variation coefficient by using the distance between the two nodes; and by calculating a delay time in the analysis target circuit by using the variation coefficient.

A circuit analysis method, a circuit analysis program, and a circuit analyzing apparatus according to the present invention are able to realize a highly-accurate timing analysis.

In addition, they are able to shorten a design time and to reduce a design cost.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a view showing a configuration of a circuit analyzing apparatus according to the present invention;

FIG. 2 is a block diagram showing the configuration of the circuit analyzing apparatus according to an embodiment of the present invention;

FIG. 3 is a diagram showing one example of a layout of an analysis target path in the circuit analyzing apparatus according to the present invention;

FIG. 4 is a diagram showing one example of a rectangle defined in calculating a distance parameter in a first embodiment;

FIG. 5 is a diagram showing one example of the rectangle moved in parallel;

FIG. 6 is a diagram showing one example of rotationally-transformed nodes and a newly defined rectangle;

FIG. 7 is a diagram showing a diagonal line length obtained by rotating a rotation angle in units of Δ° from 0° to 180°;

FIG. 8 is a graph showing one example of a minimum diagonal line length;

FIG. 9 is a diagram showing a circle defined to calculate a distance parameter in a second embodiment;

FIG. 10 is a diagram showing one example of the circle including all nodes in an analysis target path;

FIG. 11 is a diagram showing one example of a convex hull used for calculating the distance parameter according to the present invention; and

FIG. 12 is a diagram showing a rectangle defined by using the convex hull.

### DESCRIPTION OF THE PREFERRED EMBODIMENTS

Hereinafter, a circuit analyzing apparatus according to the present invention will be described in detail with reference to the attached drawings.

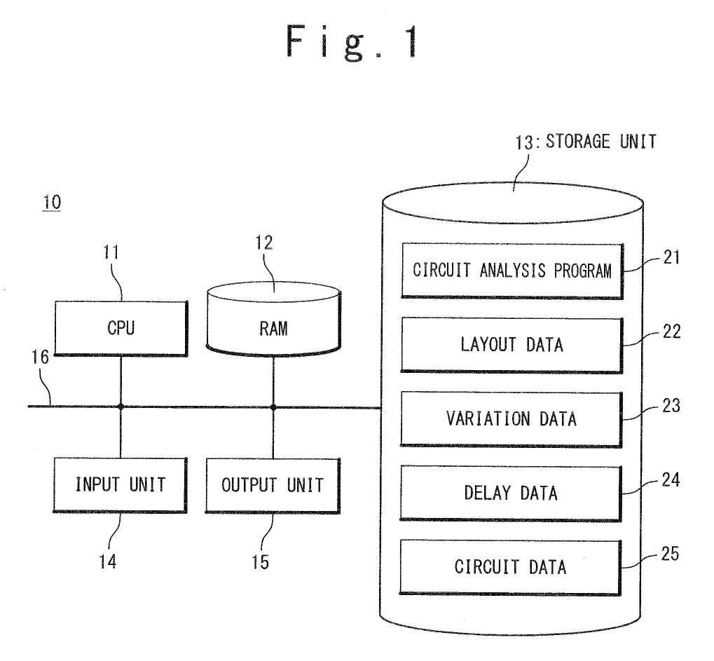

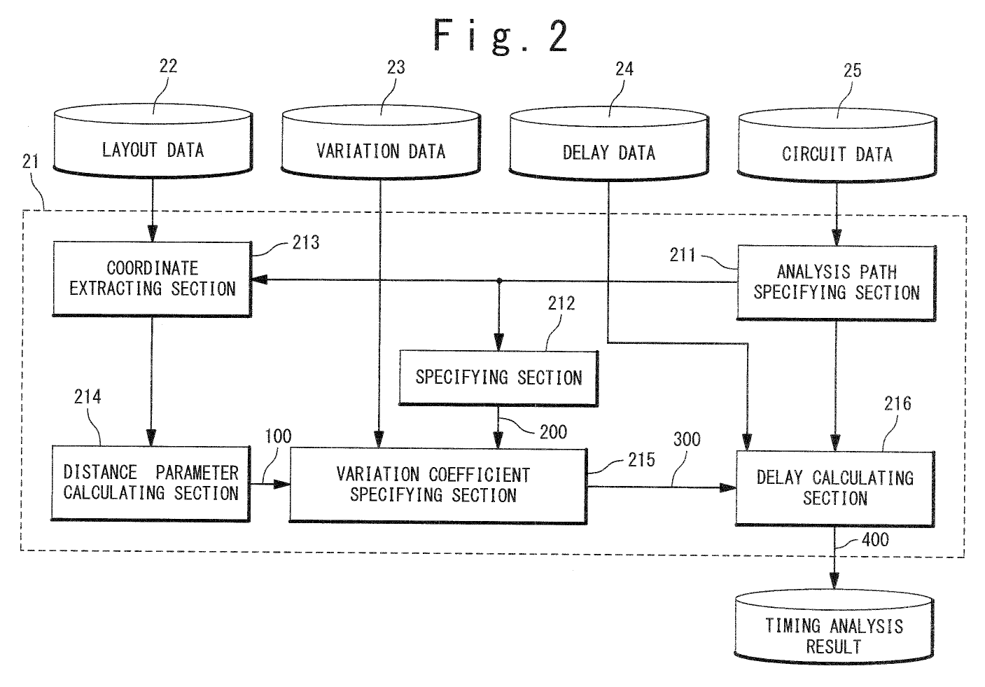

Referring to FIGS. 1 and 2, a configuration of a circuit analyzing apparatus 10 according to an embodiment of the present invention will be described. FIG. 1 is a block diagram showing a configuration of the circuit analyzing apparatus 10 according to the embodiment of the present invention. Referring to FIG. 1, the circuit analyzing apparatus 10 includes a CPU 11, a RAM 12, a storage unit 13, an input unit 14, and an output unit 15, which are connected with each other via a bus 16. The storage unit 13 is an external storage unit such as a hard disk and a memory. In addition, the input unit 14 is such as a keyboard or a mouse operated by a user to output various types of data to the CPU 11 and the storage unit 13. The output unit 15 is exemplified by a monitor or a printer and outputs a result of a layout of a semiconductor device outputted from the CPU 11 to the user in visible form.

The storage unit 13 stores a circuit analysis program 21, a layout data 22, a variation data 23, a delay data 24, and a circuit data 25. In response to an input from the input unit 14, the CPU 11 executes the circuit analysis program 21 in the storage unit 13 to carry out timing analysis. In this case, various types of data and programs from the storage unit 13 are temporarily stored in the RAM 12, and the CPU 11 executes various types of processes by using the data in the RAM 12.

Referring to FIG. 2, the layout data 22 includes position data (for example, coordinates data) of elements and interconnections in designed layout of an analysis target circuit. The layout data 22 is, for example, data in a GDS form representing a diffusion layer and an interconnection layer.

The variation data 23 is used for determining, a variation coefficient indicating variations of a delay time on two relative paths. Here, the variation coefficient includes: a systematic component in which a distance dependent variation depends on a position in a circuit and on a distance between elements (a distance parameter) on the relative paths; and a random component in which variations appear in each stage or an element on the path and are not related to variations of other elements. The systematic component is uniquely determined on the basis of the distance parameter, and the random component is uniquely determined on the basis of the number of steps of the stage. For this reason, the variation coefficient is uniquely determined on the basis of the distance parameter and the number of steps of the stage.

The variation data 23 is a measured value of the variation coefficient or a variation of the delay time between the relative paths in an LSI. In this case, the variation coefficient or a variation of the delay time measured by changing the distance parameter as a distance between a certain element and an element in another path or the number of steps of the stage or the element in the relative path is stored in the storage unit 13 as the variation data 23. That is, the variation coefficient can be uniquely determined by extracting the measured value of the variation coefficient corresponding to a specified distance parameter and to the specified number of steps of the stage from the variation data 23.

Alternately, the variation data 23 may be a function having the distance parameter and the number of steps of the stage as variables. Also, in this case, when the distance parameter and the number of steps of the stages are determined, the variation coefficient can be uniquely determined by substituting the respective values to the variation data 23 as the function. The variation data 23 shows a different value depending on a technique employed for a semiconductor integrated circuit. For example, even when values of the distance parameter and of the number of steps of the stage are the same, the variation coefficient serves as a different coefficient in a different technique. For this reason, the measured value of the variation coefficient or the function is recorded as the variation data 23 for each of the semiconductor integrated circuits manufactured by different techniques. Ideally, it is preferable to store the functions different for each technique as the variation data 23 and to calculate the variation coefficient by using the data. However, it requires effort much to determine respective functions corresponding to various techniques Accordingly, retention of the measured value of the variation coefficient as the variation data 23 is more practical than retention of the function for calculating the variation coefficient, and improves design efficiency and a design cost.

The delay data 24 shows a delay time for each path calculated or measured based on a property and a shape of an element and on a composition and a shape of an interconnection. The circuit data 25 includes data of connection between the elements in the analysis target circuit.

The circuit analysis program 21 is executed by the CPU 11 to realize respective functions of an analysis path specifying section 211, a specifying section 212, a coordinate extracting section 213, a distance parameter calculating section 214, a variation coefficient specifying section 215, and a delay calculating section 216.

The analysis path specifying section 211 specifies based on the circuit data 25, an analysis target path or a relative path as a calculation target of delay time under consideration of variations. The specifying section 212 refers to the analysis path specified by the analysis path specifying section 211 and specifies the number of steps 200 of the stages or the elements in the analysis path. The coordinate extracting section 213 extracts position coordinates (X-Y coordinates) of each of the elements in the analysis target path specified by the analysis target path specifying section 211.

The distance parameter calculating section 214 calculates a distance parameter 100 used for determining the variation coefficient on the basis of the coordinates, of the respective elements in the analysis target path, extracted by the coordinate extracting section 213,. Here, one distance parameter 100 is calculated for the whole analysis target path. A summation of the variation coefficients using the distances between elements in the relative paths is calculated as the systematic component of the variation coefficient in the above conventional technique. However, the circuit analyzing apparatus 10 according to the present invention specifies or calculates the systematic component of the variation coefficient in the analysis target path by using one distance parameter. Details of an operation of the distance parameter calculating section 214 will be described later.

The variation coefficient specifying section 215 specifies a variation coefficient 300 by using the variation data 23, the distance parameter 100, and the number of steps 200. Here, the variation coefficient specifying section 215 determines the variation data 23 depending on a technique used for an analysis target circuit. When the determined variation data 23 is a measured value of the variation coefficient, the variation coefficient specifying section 215 extracts the variation coefficient 300 corresponding to the distance parameter 100 and the number of steps 200 from the variation data 23 and outputs the extracted variation coefficient to the delay calculating section 216. Or, when the determined variation data 23 is a function of calculating the variation coefficient, the variation coefficient specifying section 215 calculates the variation coefficient 300 by substituting the distance parameter 100 and the number of steps 200 into the variation data 23.

The delay calculating section 216 calculates a delay time 400 in the analysis target path by using the delay data 24 and the variation coefficient 300 and stores the calculated time in the storage unit 13 as a result of the timing analysis. The delay calculating section 216 calculates the delay time of the analysis target path by using one distance parameter 100 calculated for the analysis target path. Accordingly, an approximate value of the delay time can be obtained in consideration of the maximum variation in the analysis target path.

### First Embodiment

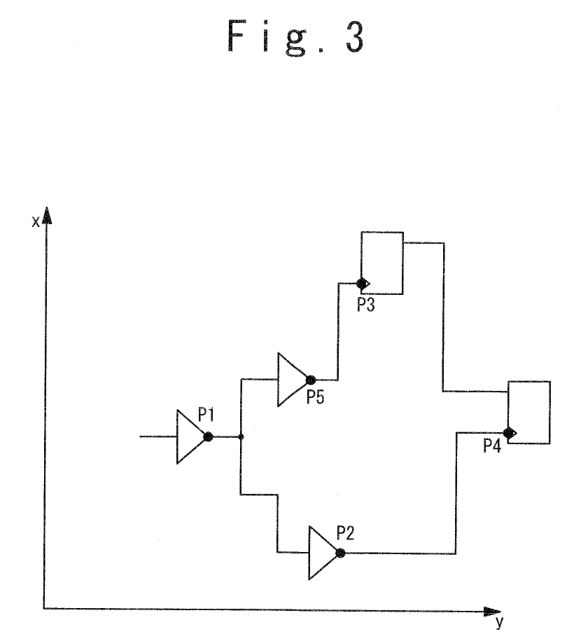

Next, referring to FIGS. 3 to 8, an operation of the distance parameter calculating section 214 according to a first embodiment of the present invention will be described. The distance parameter calculating section 214 in the first embodiment specifies a rectangle with a minimum area including all elements (hereinafter referred to as nodes) on the analysis target path and outputs a diagonal line of the rectangle as the distance parameter 100.

FIG. 3 is a diagram showing one example of the layout of the analysis target path. Supposing that the timing analysis of the analysis target path shown in FIG. 3 is carried out, the present embodiment will be described. The coordinate extracting section 213 extracts position coordinates of the nodes on the analysis target path on the basis of the layout data 22. Here, as shown in FIG. 3, points P1 to P5 are extracted as the position coordinates of the nodes.

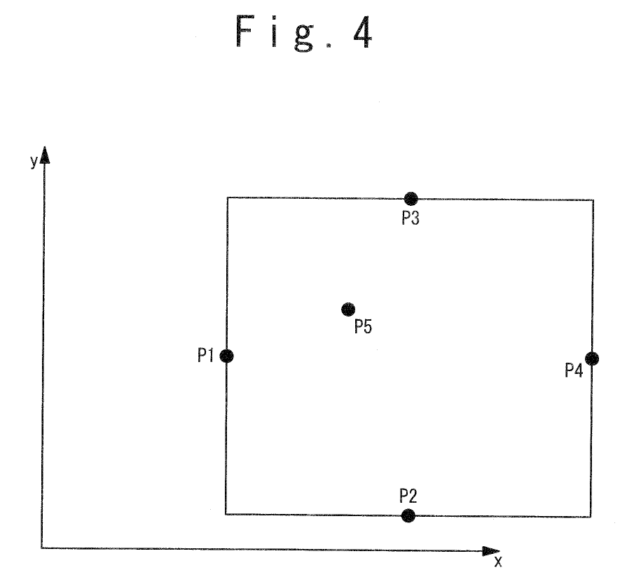

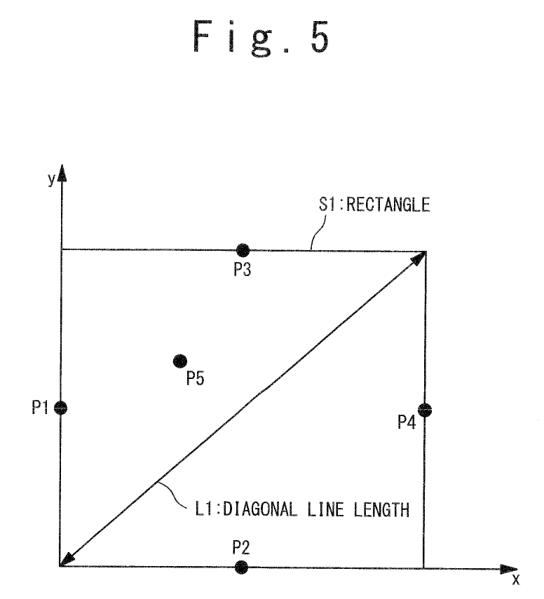

The distance parameter calculating section 214 defines a rectangle including all the nodes on the analysis target path and having sides parallel to an X axis and a Y axis. Specifically, as shown in FIG. 4, the rectangle is defined to have the sides passing the node having the minimum X coordinate (point P1), the node having the minimum Y coordinate (point P2), the node having the maximum X coordinate (point P4), and the node having the maximum Y coordinate (point P3). Then, as shown in FIG. 5, the distance parameter calculating section 214 moves the rectangle in parallel to the X axis and the Y axis to the origin. Thus, all the nodes are moved in parallel to the rectangle. The distance parameter calculating section 214 relates a diagonal line length L1 of the rectangle S1 to a rotation angle 0° and stores the related length in the storage unit 13.

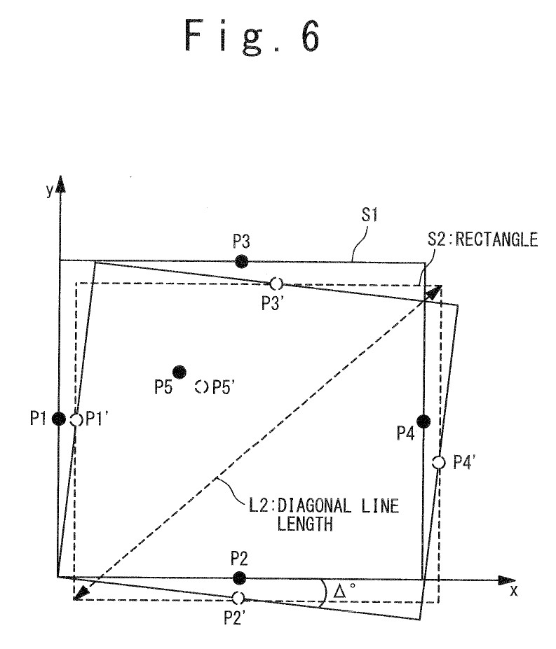

Next, referring to FIG. 6, the distance parameter calculating section 214 rotates the rectangle S1 around the origin by a predetermined angle Δ°. At this time, all the nodes (the points P1 to P5) rotate with the rectangle S1. Accordingly, the coordinates P1 to P5 of the nodes are rotationally transformed by the angle Δ° to be points P1′ to P5′. Next, the distance parameter calculating section 214 newly defines a rectangle S2 including all the rotationally-transformed nodes and having sides parallel to the X axis and the Y axis. Specifically, the rectangle S2 is defined to have the sides passing the node having the minimum X coordinate (point P1′), the node having the minimum Y coordinate (point P2′), the node having the maximum X coordinate (point P4′), and the node having the maximum Y coordinate (point P3′). Then, the distance parameter calculating section 214 relates a diagonal line length L2 of the rotationally-transformed rectangle S2 to the rotation angle Δ° and stores the related length in the storage unit 13.

In the same manner, the distance parameter calculating section 214 defines new rectangle by rotating the rectangle 2 by a predetermined angle Δ° around the origin after moving the rectangle 2 (the nodes) in parallel to the X axis, and the Y axis to the origin, and relates a diagonal line length of the new rectangle to the rotated angle (2×Δ°) and stores the related line.

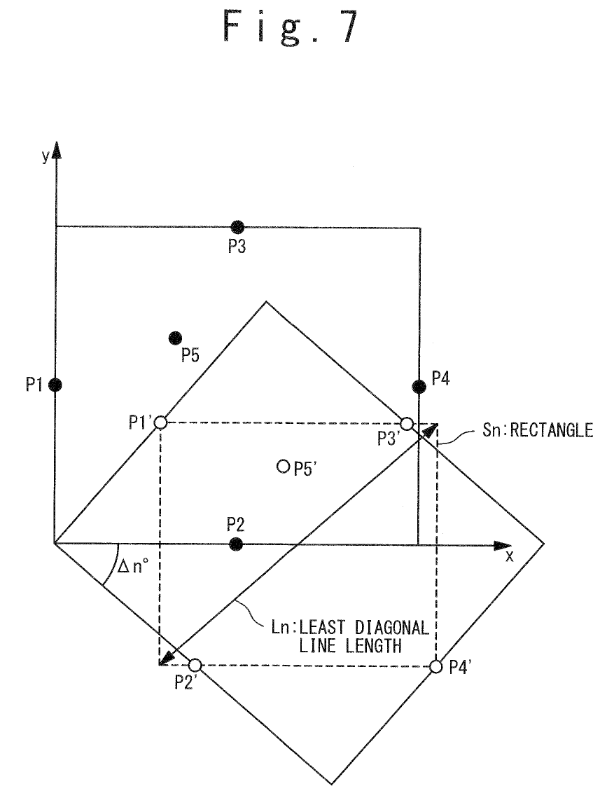

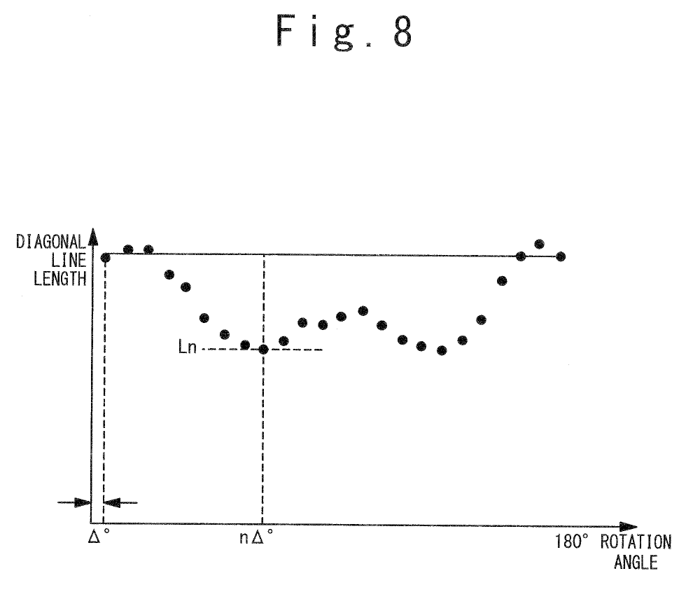

The distance parameter calculating section 214 repeats the same parallel movement and rotational transform of the nodes by using the rotation angle Δ°, and stores a diagonal line length of a rectangle defined after the rotation. FIG. 7 is a diagram showing a diagonal line length obtained by rotating in units of Δ° from 0° to 180°. Referring to FIG. 7, the diagonal line length of the rectangle is changed by rotationally transforming the rectangle and defining a new rectangle. The distance parameter calculating section 214 extracts a shortest diagonal line length Ln from the calculated diagonal line lengths and outputs the extracted length as the distance parameter 10. Here, the diagonal line length Ln of a rectangle Sn of a case where the rotation angle is n×Δ° represents a minimum value. Specifically, as shown in FIG. 8, the diagonal line length Ln of the rectangle Sn passing the points P1′ to P5′ obtained by rotationally transforming the points P1 to P5 by the angle n×Δ° is outputted as the distance parameter 100.

As described above, the distance parameter calculating section 214 in the present embodiment specifies the minimum rectangle Sn including all the nodes without changing relative positions of the nodes in the analysis target path by moving in parallel and rotationally transforming the points of the elements (the nodes) obtained from the layout data 22. Then, the distance parameter calculating section 214 outputs the minimum diagonal line length Ln in the rectangle Sn as the distance parameter 100.

The variation coefficient specifying section 215 specifies the variation coefficient 300 by using the diagonal line length Ln provided as the distance parameter 100 and the number of steps 200 of the analysis target path. The distance parameter 100 used here is a length based on the minimum rectangle including all the nodes in the analysis target path. For this reason, a minimum range of positional variations of the nodes can be reflected to the distance parameter 100 with high accuracy. Thus, according to the present invention, the distance dependent variations component (the systematic component) in the variation coefficient 300 can be calculated more accurately than the conventional technique.

In addition, since having a shorter length than that of the conventional technique, the distance parameter 100 can alleviate a pessimistic constraint condition to the timing analysis. That is, since the constraint condition to the variation of the delay time is alleviated than ever, the design margin can be reduced and time required for design convergence can be shortened.

After defining the minimum rectangle Sn as described above, the minimum rectangle (the diagonal line length) may be defined with further high accuracy by transforming In parallel and rotationally transforming the rectangle Sn by the angle smaller than the angle Δ°. In this case, the timing analysis with further high accuracy can be carried out because the further shorter diagonal line length can be used as the distance parameter 100. The rotation angle Δ° and the number of times of calculation may be appropriately selected in accordance with a size of the analysis target circuit and a performance of a computer for the calculation.

### Second Embodiment

Next, referring to FIGS. 3, 9, and 10, an operation of the distance parameter calculating section 214 according to a second embodiment of the present invention will be described. The distance parameter calculating section 214 in the second embodiment specifies a circle with a minimum area including all elements (nodes) in the analysis target path and outputs a diameter of the circle as the distance parameter 100.

Supposing that the timing analysis of the analysis target path shown in FIG. 3 is carried out, the present embodiment will be described. The coordinate extracting section 213 extracts position points of the node in the analysis target path on the basis of the layout data 22. Here, as shown in FIG. 3, the points P1 to P5 are extracted as the position coordinates of the nodes.

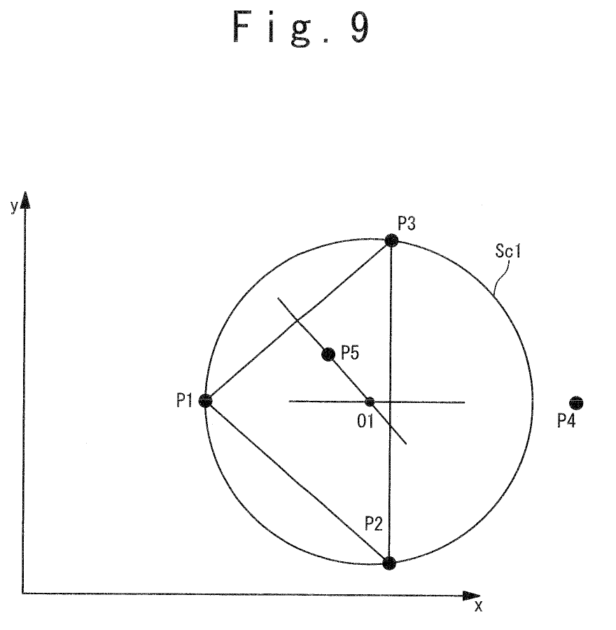

The distance parameter calculating section 214 in the present embodiment designates arbitrary three nodes from all of the nodes in the analysis target path and defines a circle passing the designated three nodes. Referring to FIG. 9, the distance parameter calculating section 214 extracts, for example, three nodes (the points P1, P2, and P3) from the nodes (the points P1 to P5) and defines an intersection point of a middle line between two points (the points P1 and P3) of the three node with a middle line between other two points (the coordinates P2 and P3) as a center O1 of a circle Sc1.

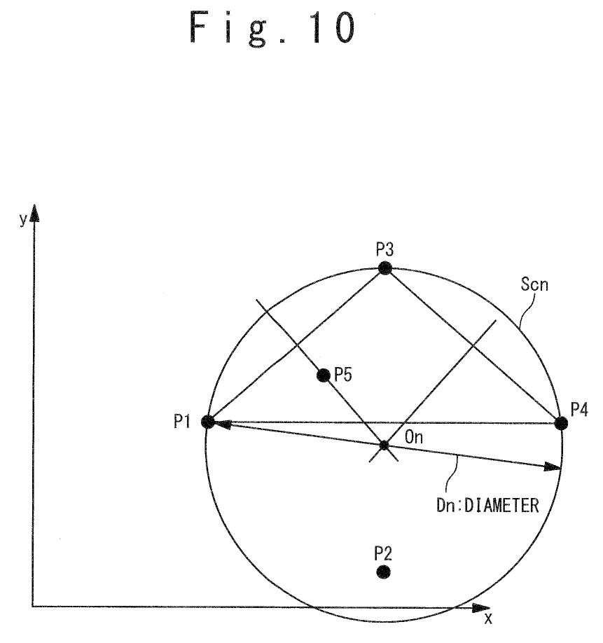

The distance parameter calculating section 214 determines whether or not the defined circle Sc1 includes all of the nodes (the points P1 to P5) in the analysis target path. On this occasion, when the circle Sc1 includes all of the nodes, the distance parameter calculating section 214 stores the diameter of the circle in the storage unit 13. For example, since a circle Scn passing the three nodes (the points P1, P3, and P4) includes all the nodes as shown in FIG. 10, the diameter Dn of the circle Scn is recorded.

The distance parameter calculating section 214 defines circles of all feasible combinations of three nodes among all the nodes in the analysis target path, determines whether or not the respective circles include all of the nodes, and stores the diameter Dn Then, the distance parameter calculating section 214 outputs, as the distance parameter 100, a shortest diameter among the recorded diameters.

As described above, the distance parameter calculating section 214 in the present embodiment specifies the minimum circle including elements (the nodes) obtained from the layout data 22 and outputs the diameter as the distance parameter 100.

The variation coefficient specifying section 215 specifies the variation coefficient 300 by using the diameter Dn provided as the distance parameter 100 and the number of steps 200 of the analysis target path. The distance parameter 100 used here is a length based on the minimum circle including all the nodes in the analysis target path. For this reason, the minimum range of positional variations of the nodes can be reflected to the distance parameter 100 with high accuracy. Thus, according to the present invention, the distance dependent variation component (the systematic component) in the variation coefficient 300 can be calculated more accurately than the conventional technique. In addition, even when a distribution profile formed by the nodes in the analysis target path is uneven, the distance parameter 100 that is an average of the unevenness can be specified because the shape including all the nodes is circular.

In addition, since having a length of the minimum circle including all the nodes, the distance parameter 100 can alleviate pessimistic constraint condition to the timing analysis. That is, since the constraint condition to the variation of the delay time is alleviated than ever, the design margin can be reduced and time required for design convergence can be shortened.

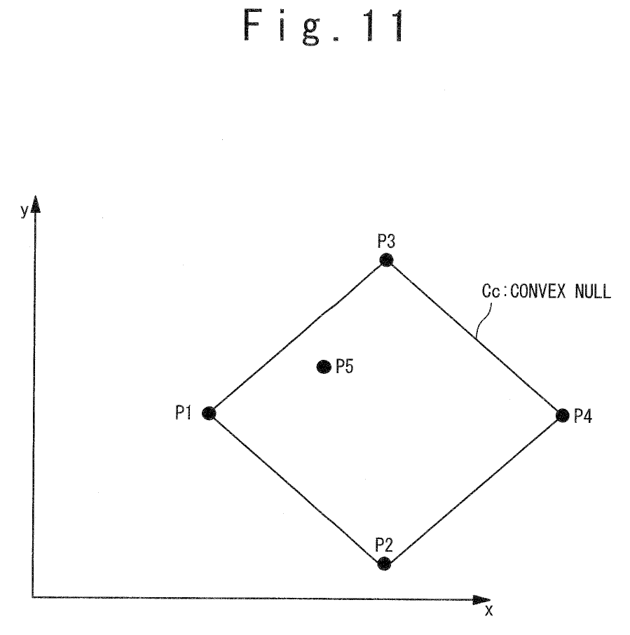

In one example described above, the distance parameter calculating section 214 defines a circle by extracting all feasible combinations of three nodes among all the nodes in the analysis target path. However, after selecting nodes necessary to determine a circle, the circle may be defined based on all feasible combinations of three nodes from the selected nodes For example, as shown in FIG. 11, the distance parameter calculating section 214 specifies a minimum convex hull Cc including all the nodes in the analysis target path and selects nodes (here, the coordinates P1, P2, P3, and P4) on this convex hull Cc. Subsequently, circles of all feasible combinations of three nodes among the selected nodes are defined, and thus the minimum diameter is specified in the same manner described above. In this manner, since the number of the combinations of three nodes used for defining the circle can be reduced by using the convex hull, a calculation amount required for calculating the distance parameter 100 can be reduced. Thus, an analysis load in the timing analysis is reduced, resulting in shortening of analysis time.

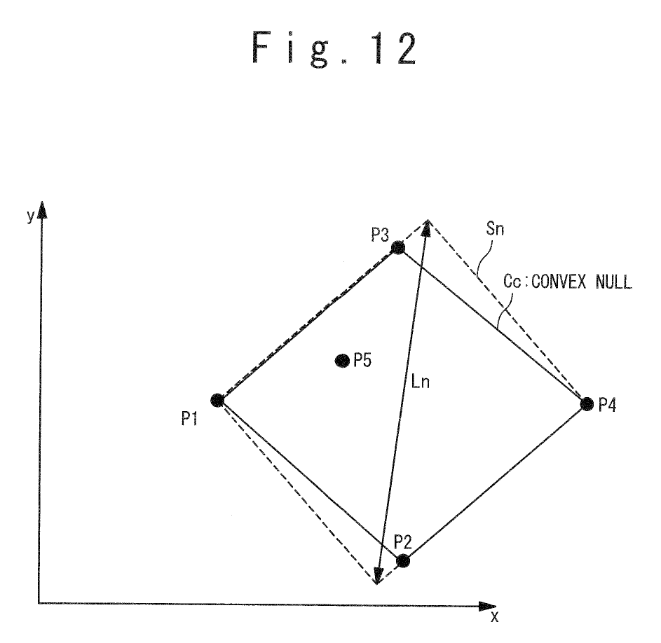

A method of reducing a calculation amount by using the convex hull Cc can be applied to the method employing the diagonal line length Ln of a rectangle as the distance parameter 100. Referring to FIG. 12, the distance parameter calculating section 214 forms the convex hull Cc by referring to coordinates of the nodes extracted from the layout data 22 and defines the minimum rectangle having a side including one side of the convex hull Cc and including all nodes in the analysis target path. The distance parameter calculating section 214 stores the diagonal line length of the defined rectangle in the storage unit 13. In the same manner, the diagonal line length of the minimum rectangle formed to have a side including any one of all sides of the convex hull. Cc and to include all the nodes is recorded. The distance parameter calculating section 214 outputs the shortest diagonal line length Ln among the recorded diagonal line lengths as the distance parameter 100. In this manner, since the number of the rectangles used for obtaining the diagonal line length can be reduced by using the convex hull, a calculation amount required for calculating the distance parameter 100 can be reduced.

In addition, the variation coefficient 300 may be specified by using a distance between most separated nodes among all the nodes on the analysis target path as the distance parameter 100. In this case, the distance parameter calculating section 214 calculates all distances between two selectable nodes among all the nodes and outputs a longest distance in the distances as the distance parameter 100. Or, the distance parameter calculating section 214 may selectively reduce the nodes used for measuring a distance between the nodes by using the convex hull as described above, and may output a longest distance between the nodes in the measured distances as the distance parameter 100.

Meanwhile, the layout of the design target circuit can be modified by using a result of the timing analysis (the delay time 400) outputted by the circuit analyzing apparatus 10 according to the present invention, and a semiconductor integrated circuit can be manufactured in accordance with a same process as in the conventional technique.

A best method as the method for calculating the distance parameter 100 can be appropriately selected from the above mentioned methods on the basis of a layout of the analysis target path and the number of elements.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A circuit analyzing method comprising:
detecting coordinate points of nodes in an analysis target circuit from layout data of said analysis target circuit to store in a storage unit;
specifying a minimum area from among areas by referring to a storage unit to read out the coordinate points of the nodes and by defining the areas containing all the nodes based on the read coordinate points of the nodes;
calculating a distance parameter prescribing a size of the minimum area;
specifying a variation coefficient by using the distance parameter; and
calculating a delay time in said analysis target circuit by using the variation coefficient.

2. The circuit analyzing method according to claim 1, wherein said specifying a minimum area comprises:
calculating a minimum circle containing all the nodes based on the coordinate points of the nodes, and
said calculating a variation coefficient comprises:
specifying the variation coefficient by using a diameter of the minimum circle.

3. The circuit analyzing method according to claim 2, wherein said calculating a minimum circle comprises:
finding a circle passing three nodes selected from the nodes; and
determining whether or not all the nodes are contained in the circle passing the three nodes.

4. The circuit analyzing method according to claim 3, wherein said finding comprises:
calculating a convex hull containing all the nodes; and
selecting the three nodes from nodes in sides of the convex hull.

5. The circuit analyzing method according to claim 1, wherein said calculating a distance parameter comprises:
calculating a diagonal line length of a minimum rectangle which contains all the nodes, based on the coordinate points of the nodes, and
said specifying a variation coefficient comprises:
specifying the variation coefficient by using the diagonal line length of the minimum rectangle.

6. The circuit analyzing method according to claim 5, wherein said calculating a diagonal line length of a minimum rectangle comprises:
changing the coordinate points of the nodes by rotating the nodes by a predetermined angle around a reference point;
calculating the diagonal line length of a rectangle containing all the nodes whose coordinate points are changed, and having two sides parallel to an x-axis and two sides parallel to a y-axis orthogonal to the x-axis;
repeating said changing the coordinate points of the nodes and said calculating the diagonal line length of a rectangle; and
selecting a minimum one from among calculated diagonal line lengths.

7. The circuit analyzing method according to claim 5, wherein said calculating a diagonal line length of a minimum rectangle comprises:
calculating the convex hull containing all the nodes;
calculating a first diagonal line length of a rectangle which has one of sides of said convex hull and a side orthogonal to the side;
calculating a second diagonal line length of a rectangle which has another side of the sides of said convex hull and a side orthogonal to the other side; and
comparing the first diagonal line length and the second diagonal line length.

8. A circuit analyzing method comprises:
detecting coordinate points of nodes in an analysis target circuit from layout data of the analysis target circuit;
specifying two nodes of the nodes based on the coordinate points of the nodes such that a distance between the two nodes is maximum;
specifying a variation coefficient by using the distance between the two nodes; and
calculating a delay time in the analysis target circuit by using the variation coefficient.

9. A circuit analyzing apparatus comprising:
a storage unit which stores layout data of an analysis target circuit;
an analysis path position specifying section configured to detect coordinate points of nodes in the analysis target circuit from the layout data of the analysis target circuit;
a distance parameter calculating section configured to define areas containing all the nodes based on the coordinate points of the nodes, specify a minimum area from among the areas and calculate a distance parameter prescribing a size of the minimum area;
a variation coefficient specifying section configured to specify a variation coefficient by using the distance parameter; and
a delay time calculating section configured to calculate a delay time in the analysis target circuit by using the variation coefficient.

10. The circuit analyzing apparatus according to claim 9, wherein said distance parameter calculating section calculates a minimum circle containing all the nodes based on the coordinate points of the nodes, and
said variation coefficient specifying section specifies the variation coefficient by using a diameter of the minimum circle.

11. The circuit analyzing apparatus according to claim 10, wherein said distance parameter calculating section finds a circle passing three nodes selected from the nodes, and determines whether or not all the nodes are contained in the circle passing the three nodes.

12. The circuit analyzing apparatus according to claim 11, wherein said distance parameter calculating section calculates a convex hull containing all the nodes, and selects the three nodes from nodes in sides of the convex hull.

13. The circuit analyzing apparatus according to claim 9, wherein said distance parameter calculating section calculates a diagonal line length of a minimum rectangle which contains all the nodes, based on the coordinate points of the nodes, and
said variation coefficient specifying section specifies the variation coefficient by using the diagonal line length of the minimum rectangle.

14. The circuit analyzing apparatus according to claim 13, wherein said distance parameter calculating section rotates the nodes by a predetermined angle around a reference point to change the coordinate points of the nodes, calculates the diagonal line length of a rectangle containing all the nodes whose coordinate points are changed, and having two sides parallel to an x-axis and two sides parallel to a y-axis orthogonal to the x-axis, repeats the change of the coordinate points of the nodes and the calculation of the diagonal line length of a rectangle, and selects and outputs a minimum one from among calculated diagonal line lengths.

15. The circuit analyzing apparatus according to claim 13, wherein said distance parameter calculating section calculates the convex hull containing all the nodes, calculates a first diagonal line length of a rectangle which has one of sides of said convex hull and a side orthogonal to the side, calculates a second diagonal line length of a rectangle which has another side of the sides of said convex hull and a side orthogonal to the other side, and compares the first diagonal line length and the second diagonal line length.

16. A circuit analyzing apparatus comprising:
a storage unit which stores layout data of an analysis target circuit;
an analysis path position specifying section configured to configured to detect coordinate points of nodes in the analysis target circuit from the layout data of the analysis target circuit;
an analysis path position specifying section configured to detect coordinate points of nodes in the analysis target circuit from the layout data of the analysis target circuit;
a distance parameter calculating section configured to specify two nodes of the nodes based on the coordinate points of the nodes such that a distance between the two nodes is maximum;
a variation coefficient specifying section configured to specify a variation coefficient by using the distance between the two nodes; and
a delay time calculating section configured to calculate a delay time in the analysis target circuit by using the variation coefficient.

17. A computer-readable recording medium in which a computer-readable program code is stored to realize a circuit analyzing method, which comprises:
detecting coordinate points of nodes in an analysis target circuit from layout data of said analysis target circuit;
specifying a minimum area from among areas by defining the areas containing all the nodes based on the coordinate points of the nodes;
calculating a distance parameter prescribing a size of the minimum area;
specifying a variation coefficient by using the distance parameter; and
calculating a delay time in said analysis target circuit by using the variation coefficient.

18. The computer-readable recording medium according to claim 17, wherein said specifying a minimum area comprises:
calculating a minimum circle containing all the nodes based on the coordinate points of the nodes, and
said calculating a variation coefficient comprises:
specifying the variation coefficient by using a diameter of the minimum circle.

19. The computer-readable recording medium according to claim 18, wherein said calculating a minimum circle comprises:
finding a circle passing three nodes selected from the nodes; and
determining whether or not all the nodes are contained in the circle passing the three nodes.

20. A computer-readable recording medium in which a computer-readable program code is stored to realize a circuit analyzing method, which comprises:
detecting coordinate points of nodes in an analysis target circuit from layout data of the analysis target circuit;
specifying two nodes of the nodes based on the coordinate points of the nodes such that a distance between the two nodes is maximum;
specifying a variation coefficient by using the distance between the two nodes; and
calculating a delay time in the analysis target circuit by using the variation coefficient.
